(19) United States
(12) Patent Application Publication
(10) Pub. No.: US 2025/0004859 A1
(43) Pub. Date: Jan. 2, 2025

(54) METHODS AND APPARATUS FOR MANAGING PLURAL CLOUD VIRTUALISATION LAYERS IN A COMMUNICATION NETWORK

(71) Applicant: Telefonaktiebolaget LM Ericsson (publ), Stockholm (SE)

(72) Inventors: Carla MOURADIAN, Montreal, Quebec (CA); Róbert SZABÓ, Budapest (HU); Ákos RECSE, Halasztelek (HU); Xumei GAN, Aachen, North Rhine-Westphalia (DE); Wubin LI, Kirkland,Quebec (CA)

(73) Assignee: Telefonaktiebolaget LM Ericsson (publ), Stockholm (SE)

(21) Appl. No.: 18/709,811

(22) PCT Filed: Dec. 6, 2021
(86) PCT No.: PCT/EP2021/084432

§ 371 Date: May 14, 2024

(51) Int. Cl. G06F 9/50; H04L 67/10

(52) U.S. Cl. CPC G06F 9/5077; H04L 67/10

(57) ABSTRACT

A method of managing plural cloud virtualisation layers in a communication network, the method comprising: receiving, from a tenant, a service request to execute an application on a host resource, wherein the service request comprises input parameters; determining, based on the input parameters, that execution of the application on the host resource requires plural cloud virtualisation layers; responsive to determining that execution requires plural cloud virtualisation layers, generating a layout of virtualisation layer components for the plural cloud virtualisation layers; and assigning the application to a virtualisation layer component based on the input parameters.

### TECHNICAL FIELD

Embodiments of the present disclosure relate to methods and apparatus of managing plural cloud virtualisation layers in a communication network, and in particular methods and apparatus for providing automated lifecycle management (LCM) of a multi-layer cloud stack.

### BACKGROUND

Distributed cloud systems combine telecommunications technology and cloud technology (i.e. the provision of on-demand access to computing resources via the internet) such that both technologies run applications across multiple sites. Such sites include national sites (that can be used for centralised applications), regional sites, and access sites (that provide cloud capabilities closer to end-users and host applications which require low latency).

When cloud technologies (also referred to as virtualisations) are used as the enabler, each site may be equipped with multiple virtualisation layers (i.e. multi-layer cloud stacks), such as OpenStack and/or Kubernetes (also referred to as K8s) virtualisation layers. In cloud systems which utilise multiple virtualisation layers, workloads may be hosted in different virtualisation layers. For example, an application-specific workload may be assigned to an OpenStack virtualisation layer and/or a Kubernetes virtualisation layer. The application-specific workload may be assigned as a container or as a virtual machine (VM). Certain application-specific workloads may be assigned as a container application in a Kubernetes cluster on a bare-metal server (i.e. a physical computer server that is used by a tenant).

FIG. 1 illustrates three deployment types of cloud stack layers (i.e. cloud virtualisation layers). The left-hand deployment type illustrates hardware on which a Virtual Network Function (VNF) is assigned to a VM in OpenStack. The middle deployment type illustrates hardware on which a Cloud Native Function (CNF) is assigned to a container in Kubernetes. The right-hand deployment illustrates a VFN assigned to a VM in OpenStack and two CNFs assigned to a container in Kubernetes on the same hardware (i.e. a multi-layer cloud stack implemented using OpenStack and Kubernetes).

While a multi-layer cloud stack system may provide flexibility and elasticity for service provisioning, it also increases the complexity of LCM during the design and assign stage of a service instance (i.e. designing the multi-cloud stack arrangement and assigning applications to components of the arrangement). In particular, complexity of LCM is increased due to certain cloud stack layers imposing requirements and constraints on the design and assign stage. Such requirements and constraints include, for example, a resilient setup of a Kubernetes cluster by imposing topology and resource mapping constraints. In order to address the complexity of LCM in a multi-layer cloud stack, LCM automation is desired.

In the present context, LCM refers to the level of cloud stacks (e.g. scaling in or out the size or changing the topology of the cloud stacks), rather than LCM of the workloads hosted on the cloud stacks

Typical methods for LCM automation focus on service provisioning and LCM in infrastructures with a single-layer cloud stack. “B. Jaumard, A. Shaikh and C. Develder, “Selecting the best locations for data centers in resilient optical grid/cloud dimensioning,” 2012 14th International Conference on Transparent Optical Networks (ICTON), Coventry, U K, 2012, pp. 1-4″ considers LCM optimisation in relation to link bandwidths, the location of server infrastructures (i.e. datacentres) and the amount of required server resources for storage and/or processing. “Coutinho, R., Frota, Y., Ocaña, K. et al. A Dynamic Cloud Dimensioning Approach for Parallel Scientific Workflows: a Case Study in the Comparative Genomics Domain. J Grid Computing 14, 443-461 (2016)” focuses on LCM of VMs. In particular, a heuristic algorithm is considered for defining the number of VMs during workload execution as well as a monitoring system to monitor the resources usage of the VMs. “Daniel de Oliveira, Vitor Viana, Eduardo Ogasawara, Kary Ocana, and Marta Mattoso. 2013. Dimensioning the virtual cluster for parallel scientific workflows in clouds. In Proceedings of the 4th ACM workshop on Scientific cloud computing (Science Cloud '13). Association for Computing Machinery, New York, NY, USA, 5-12” focuses on VM-level resource provisioning, in which a multi-objective cost function is proposed to determine a preferred initial configuration for a virtual cluster while considering workflow characteristics with a budget and deadline constraints.

Typical methods for LCM automation suffer from the following problems:
Existing methods primarily focus on resource dimensioning for each component of a service, while the structural LCM dependencies of multi-layer cloud stacks are ignored.
No existing method provides a model-driven approach for LCM of multi-layer cloud stack. Instead, existing methods assume that cloud stacks are ready for workload hosting.
None of the existing methods provide a means for integration of service instance design and assign with virtual infrastructure design to support LCM automation.
Typical virtualisation layers are changed very slowly hence need to be overprovisioned so that service orchestration has sufficient resources under most conditions.

### SUMMARY

It is an object of the present disclosure to provide methods of managing plural cloud virtualisation layers by automating mechanisms to instantiate, scale and/or decommission cloud virtualisation layers on-demand at a service instance design and assign time.

Aspects of embodiments provide a network node, methods and computer programs which at least partially address one or more of the challenges discussed above.

An aspect of the disclosures provides a method of managing plural cloud virtualisation layers in a communication network. The method comprising receiving, from a tenant, a service request to execute an application on a host resource. The service request comprises input parameters. The method further comprises determining, based on the input parameters, that execution of the application on the host resource requires plural cloud virtualisation layers. The method further comprises, responsive to determining that execution requires plural cloud virtualisation layers, generating a layout of virtualisation layer components for the plural cloud virtualisation layers. The method further comprises assigning the application to a virtualisation layer component based on the input parameters.

Advantageously, the method of managing plural cloud virtualisation layers provides a means for LCM automation of plural cloud virtualisation layers (i.e. multi-layer cloud stacks) during service instance design and assign as an extension to a workload placement algorithm.

Optionally, the input parameters may define virtualisation requirements comprising at least one of: required resource constraints, required redundancy level, and required decomposition type. The layout of virtualisation layer components may be generated by creating clusters of virtualisation layer components for respective cloud virtualisation layers according to at least one of: the required resource constraints, the required redundancy level, and the required decomposition type.

Generating the layout of virtualisation layer components based on input parameters, as defined above, ensures the application is executed effectively and efficiently in accordance with requirements defined by the tenant.

Optionally, context parameters may be received from an infrastructure manager. The context parameters may define virtualisation requirements comprising at least one of: host resource constraints, dependencies between cloud virtualisation layers, and host resource topology. The method may further comprise determining that assignment of the application to the host resource requires plural cloud virtualisation layers based on the input parameters and the context parameters. The layout of virtualisation layer components may be generated by creating clusters of virtualisation layer components for respective cloud virtualisation layers according to at least one of: the required resource constraints, the required redundancy level, the required decomposition type, the host resource constraints, the dependencies between cloud virtualisation layers, and the host resource topology. The application may be assigned to a virtualisation layer component based on the input parameters and the context parameters

Generating the layout of virtualisation layer components based on input parameters and context parameters, as defined above, ensures the application is executed effectively and efficiently in accordance with requirements defined by the tenant and the infrastructure manger.

Another aspect of the disclosure provides a network node configured to manage plural cloud virtualisation layers in a communication network. The network node comprises processing circuitry and a memory containing instructions executable by the processing circuitry. The network node is operable to receive, from a tenant, a service request to execute a application on a host resource, wherein the service request comprises input parameters. The network node is further operable to determine, based on the input parameters, that execution of the application on the host resource requires plural cloud virtualisation layers. The network node is further operable to, responsive to determining that execution requires plural cloud virtualisation layers, generate a layout of virtualisation layer components for the plural cloud virtualisation layers. The network node is further operable to assign the application to a virtualisation layer component based on the input parameters.

Another aspect of the disclosure provides a computer-readable medium comprising instructions for performing the methods set out above, which may provide equivalent benefits to those set out above.

Further aspects provide apparatuses and computer-readable media comprising instructions for performing the methods set out above, which may provide equivalent benefits to those set out above.

### BRIEF DESCRIPTION OF DRAWINGS

For a better understanding of the present disclosure, and to show how it may be put into effect, reference will now be made, by way of example only, to the accompanying drawings, in which:

FIG. 1 is a schematic diagram illustrating three deployment types of cloud virtualisation layers;

FIG. 2 is a flowchart illustrating a method of managing plural cloud virtualisation layers;

FIG. 3A is a schematic diagram of a network node for managing plural cloud virtualisation layers;

FIG. 3B is another schematic diagram of a network node for managing plural cloud virtualisation layers;

FIG. 4 is a flowchart illustrating an embodiment of the method of managing plural cloud virtualisation layers;

FIG. 5 is another flowchart illustrating a more detailed embodiment of the method of managing plural cloud virtualisation layers;

FIG. 6 is a flow diagram illustrating an actor and role model representation of the method of managing plural cloud virtualisation layers;

FIG. 7 is a schematic diagram illustrating another embodiment of the method of managing plural cloud virtualisation layers;

FIG. 8 is a schematic diagram illustrating the manner in which multi-layer cloud stacks may be triggered and created; and

FIG. 9 is a flowchart illustrating another embodiment of the method of managing plural cloud virtualisation layers.

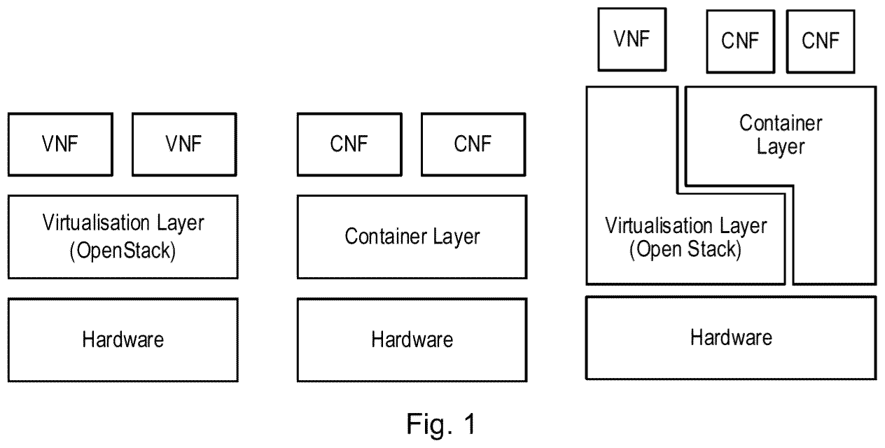

### DETAILED DESCRIPTION

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Embodiments of the present disclosure provide methods of managing plural cloud virtualisation layers by combining LCM procedures corresponding to individual virtualisation layers in order to efficiently perform design and assign of a service instance (i.e. an application) in a multi-layer cloud stack. Design and assign of an application is performed by using the combined LCM procedures to determine a layout of virtualisation layer components and to assign the application to a certain virtualisation layer component.

When referring to specific types of virtualisation layers in the following description, reference will be made to an OpenStack virtualisation layer and a Kubernetes virtualisation layer. It will be understood that embodiments of the present invention can be applied to any virtualisation layer. Examples of other types of virtualisation layers to which embodiments of the present invention apply include a Java Virtual Machine (JVM) virtualisation layer and a hypervisor-based virtualisation layer.

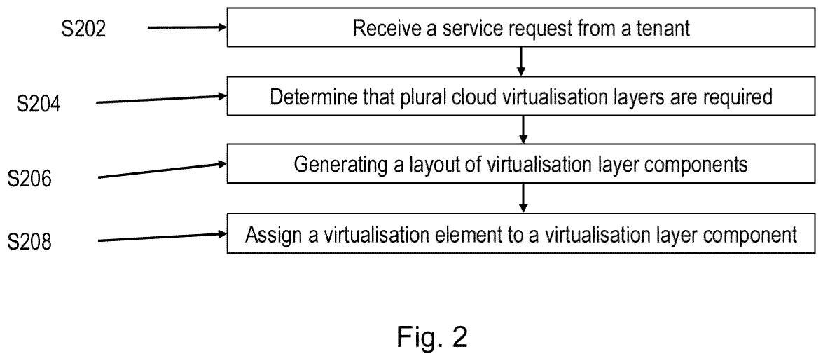

FIG. 2 is a flowchart illustrating a method of managing plural cloud virtualisation layers performed by a network node (e.g. a core network node, a radio access node, a base station node, a user equipment (UE) node, etc.). In particular, the management method receives a service request from a tenant, determines that plural cloud virtualisation layers are required, generates a layout of virtualisation layer components, and assigns an application to a virtualisation layer component.

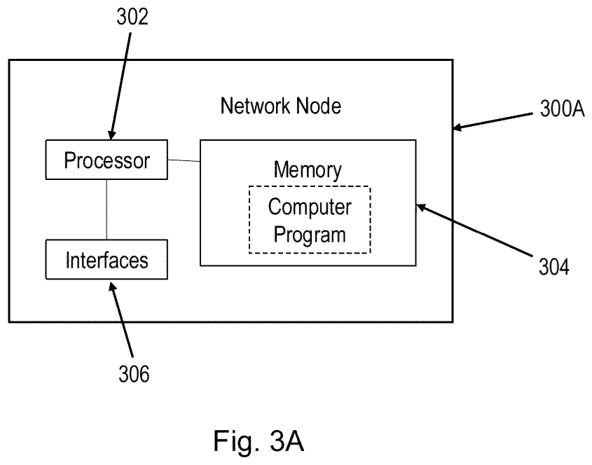

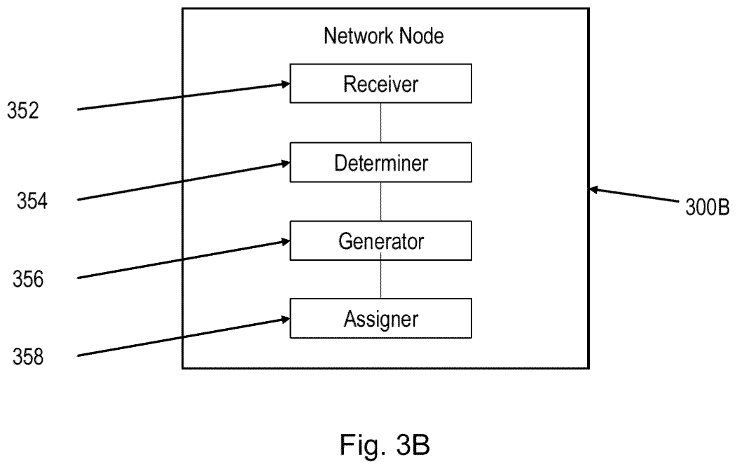

FIGS. 3A and 3B show network nodes 300A and 300B in accordance with certain embodiments. The network nodes 300A and 300B are examples of devices that may perform the method of FIG. 2. The method of managing plural cloud virtualisation layers in performed in a communication system. The communication system may be a telecommunications system such as, for example, a 3GPP 5G network (i.e. a 5th generation new radio (5G NR) network).

In step S202, a service request to execute an application on a host resource is received at the network node 300A, 300B from a tenant, wherein the service request comprises input parameters. The service request may be a request to execute an application on one or more cloud virtualisation layers in a distributed cloud system. The tenant from which the service request is transmitted may be an individual user (i.e. single-tenancy) or a group of users (i.e. multi-tenancy). Receiving the service request may be performed, for example, by the processor 302 of the network node 300A running a program stored on the memory 304 in conjunction with the interfaces 306, or may be performed by a receiver 352 of the network node 300B.

Input parameters are comprised in the service request for the purpose of determining the manner in which the application should be executed. The input parameters may define virtualisation requirements which are used in subsequent steps of the management method to determine the layout of virtualisation layer components and to assign the application to a virtualisation layer component. The virtualisation requirements defined by the input parameters may comprise at least one of the following:
required resource constraints: the required resource constraints may define certain requirement of the host resource necessary to execute the application. Such requirements may include: latency rules (i.e. the maximum permissible processing latency), geolocation rules (i.e. restrictions on geographical locations at which the application may be executed on a host resource), affinity/anti-affinity rules (i.e. rules defining under which conditions the plural virtualisation layers should adhere to the virtualisation requirements), multi-tenant rules (i.e. whether multi-tenancy or single-tenancy should be used), capacity rules (i.e. the minimum capacity required by the host resource), and link bandwidth utilisation rules (i.e. how the available bandwidth should be used by the plural virtualisation layers).
required redundancy level: the required redundancy level may define a resource topology required to ensure a certain level of redundancy. For example, the required redundancy level may define high, medium and low levels of redundancy, wherein the high redundancy level requires three backup virtualisation layer components for at least one cloud virtualisation layer, the medium redundancy level requires two backup virtualisation layer components for at least one cloud virtualisation layer, and the low redundancy level requires one backup virtualisation layer component for at least one cloud virtualisation layer.
required decomposition type: the required decomposition type may define the manner in which the application should be decomposed. For example, in a multi-layer cloud stack comprising an OpenStack virtualisation layer and a Kubernetes virtualisation layer, the decomposition type may be, for example, a Kubernetes decomposition, an OpenStack decomposition, or Kubernetes on OpenStack decomposition.

The host resource may be a virtual resource on which the application is executed. The method may further comprise converting a physical host resource (e.g. CPU) to the virtual host resource (e.g. vCPU). For example, the physical host resource may be hardware such as CPU of a computer server which is converted to a vCPU to be used as a virtual host resource on which the plural virtualisation layers are hosted in order to execute the application. Conversion from a physical host resource to a virtual host resource may be performed by another component which is responsible for virtualisation management. In an OpenStack cluster for example, the OpenStack LCM may reserve certain CPU cores across all the physical nodes for the host processes (i.e. for efficiency) and assign any remaining CPU cores to VM instances.

Furthermore, a vCPU-to-core ratio may be defined in order to determine the number of vCPUs available for VM instances. For example, if the ratio is 4:1, and there are five CPU cores available, the conversion will generate 4×5=20 vCPUs for VM instances.

An application may be a single VNF, a single CNF, a group of VNFs, a group of CNFs, or a group of VNFs and CNFs. Alternatively, an application may be referred to as a workload.

In step S204, the network node 300A, 300B is configured to determine that plural cloud virtualisation layers are required to execute the application based on the input parameters. That is, the input parameters received from the tenant are processed in order to determine the number of cloud virtualisation layers required to execute the application. If the network node 300A, 300B determines that a single cloud virtualisation layer is required, the application is executed on a single cloud virtualisation layer. If the network node 300A, 300B determines that plural cloud virtualisation layers are required, the application is executed on plural cloud virtualisation layers according to embodiments of the present invention. The network node 300A, 30B may determine that plural cloud virtualisation layers are required if the input parameters define virtualisation requirement indicating that more than one cloud virtualisation layer should be used (i.e. based on the required resource constraint) and/or that decomposition is required (i.e. based on the required decomposition type). Determining that plural cloud virtualisation layers are required may be performed, for example, by the processor 302 of the network node 300A running a program stored on the memory 304 in conjunction with the interfaces 306, or may be performed by a determiner 354 of the network node 300B.

In step S206, the network node 300A, 300B generates the layout of virtualisation layer components for the plural cloud virtualisation layers in response to determining that plural cloud virtualisation layers are required. A virtualisation layer component may be a specific part of a cloud virtualisation layer. For example, in a OpenStack virtualisation layer, a virtualisation layer component may be a Controller component or a Compute component. Whereas, in a Kubernetes virtualisation layer, a virtualisation layer component may be a Master component or a Worker component. In certain embodiments, a virtualisation layer component may be referred to as a sub-cluster and a group of virtualisation layer components in the same cloud virtualisation layer may be referred to as a cluster. Generating the layout of virtualisation layer components may be performed, for example, by the processor 302 of the network node 300A running a program stored on the memory 304 in conjunction with the interfaces 306, or may be performed by a generator 356 of the network node 300B.

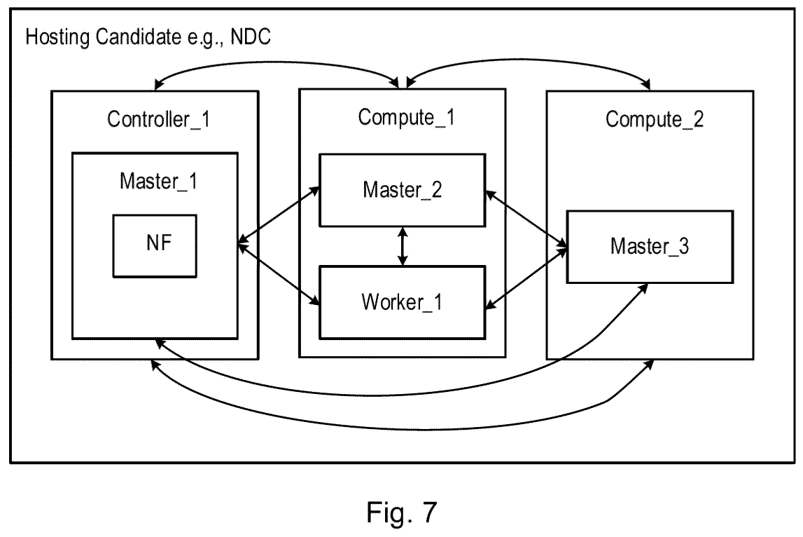

The layout of virtualisation layer components may define a topology of the plural cloud virtualisation layers required to execute the application. For example, the layout may define the manner in which decomposition is performed for the particular cloud virtualisation layers being used in the execution. According to certain embodiments, the layout of virtualisation layer components is generated by creating clusters of virtualisation layer components (i.e. groups of virtualisation layer components) for respective cloud virtualisation layers according to at least one of: the required resource constraints, the required redundancy level, and the required decomposition type. For example, if the required decomposition type defines that decomposition of plural cloud virtualisation layers are required, at least two virtualisation layer components are generated each corresponding to a different cluster. If the required redundancy level defines a high redundancy level, three backup virtualisation layer components are generated for at least one cloud virtualisation layer. In some embodiments, the required decomposition type may define that decomposition for Kubernetes and OpenStack is required, in which case the virtualisation layer components may be generated as an arrangement of Controller, Compute, Master, and/or Worker components, as discussed in more detail below in relation to FIG. 7.

Creating clusters of virtualisation layer components may comprise recursively (i.e. repeatedly) generating virtual layer components for respective clusters until the required number of virtualisation requirements is satisfied. For example, in embodiments where the plural cloud virtualisation layers comprise two cloud virtualisation layers each having one corresponding cluster, virtual layer components may be recursively generated for each cluster until the maximum number of virtualisation requirements is satisfied. The maximum number of virtualisation requirements that can be satisfied may be fewer than the total number of virtualisation requirements defined by the input parameters and the context parameters (e.g. due to limited availability of host resource candidates). The minimum number of virtualisation requirements that should be satisfied may be defined by the required redundancy level (e.g. a Kubernetes layer with high redundancy requirements may require at least three Master nodes and one Worker node”).

According to certain embodiments, each cluster of virtualisation layer components may be created using an LCM of a corresponding cloud virtualisation layer. For example, an OpenStack LCM may be used to recursively create clusters of virtualisation layer components for an OpenStack cloud virtualisation layer and a Kubernetes LCM may be used to recursively create clusters of virtualisation layer components for a Kubernetes cloud virtualisation layer. Advantageously, the use of two different LCMs in the same process improves the efficiency of managing plural cloud virtualisation layers.

In step S208, the network node 30A, 300B assigns the application to a virtualisation layer component based in the input parameters. That is, based on the virtualisation requirements defined by the input parameters, the application is assigned to at least one virtualisation layer component responsible for executing the application on the host resource. In certain embodiments, the application may be assigned to one or more virtualisation layer components based on the virtualisation requirements (i.e. different elements of the application may be assigned to different virtualisation layer components). Assigning the application to a virtualisation layer component may be performed, for example, by the processor 302 of the network node 300A running a program stored on the memory 304 in conjunction with the interfaces 306, or may be performed by a assigner 358 of the network node 300B.

According to certain embodiments, the method of managing plural cloud virtualisation layers may further comprise receiving, at the network node 300A, 300B, context parameters from an infrastructure manager, wherein the context parameters define virtualisation requirements. The virtualisation requirements defined by the context parameters differ to the virtualisation requirements defined by the input parameters in that they define requirements of the host resource according to the infrastructure manager. The context parameters may be used in combination with the input parameters in subsequent steps of the management method to determine that plural cloud virtualisation layers are required, to determine the layout of virtualisation components, and to assign the application to a virtualisation layer component.

The virtualisation requirements defined by the context parameters may comprise at least one of the following:
host resource constraints: the host resource constraints may define restrictions of the available host resource. Such restrictions may include: minimum latency (i.e. the minimum available processing latency), geolocation restrictions (i.e. available geographical locations at which the application may be executed on the host resource), capacity rules (i.e. the maximum available capacity provided by the host resource).
dependencies between cloud virtualisation layers (i.e. whether certain cloud virtualisation can or can't be used together when generating the layout of virtualisation components).
host resource topology: the host resource topology may define the manner in which the host resource topology can be arranged (e.g. whether or not certain types of virtualisation components can be used together on the same host resource).

The infrastructure manager may be a node of the communication network configured to analyse available host resources and provide feedback on the host resource analysis to the network node in the form of context parameters. These context parameters may be subsequently used in combination with the input parameters, as discussed above.

In certain embodiments, the context parameters may further define the virtualisation requirement of existing host resource topology, wherein the existing host resource topology indicates an existing cluster of virtualisation layer components on the host resource. The existing cluster of virtualisation layer components may define one or more virtualisation layer components which have been previously created and assigned to the host resource and that are available for use by the network node 300A, 300B as part of the management method. It will be understood that the existing host resource topology may define plural existing clusters of virtualisation layer components.

The existing cluster of virtualisation components may be updated before being selected and used in generating the layout of virtualisation layer components. For example, plural existing clusters of virtualisation layer components may be selected by the network node 300A, 300B to be used in generating the layout of virtualisation layer components. That is, the existing clusters of virtualisation layer components may be rearranged in order to generate the layout of virtualisation layer components in accordance with embodiments of the present inventions.

According to some embodiments, new virtualisation layer components may be created to be used in addition to the existing cluster of virtualisation layer components in generating the layout of virtualisation layer components. For example, new clusters of virtualisation layer components may be generated as part of the generating step S206 and combined with at least one existing cluster of virtualisation components in order to generate the layout of virtualisation layer components in accordance with embodiments of the present inventions.

Advantageously, by utilising existing virtualisation layer components, plural cloud virtualisation layers may be efficiently managed.

Generating the layout of virtualisation layer components may further comprise decommissioning one of the plural cloud virtualisation layers. For example, during the process of generating the layout, cloud virtualisation layers which do not meet virtualisation requirements defined by the input parameters and/or the context parameters may be decommissioned. Advantageously, by decommissioning incompatible cloud virtualisation layers, addition capacity may be created on the host resource.

The method of managing plural cloud virtualisation layers may further comprise selecting the most appropriate host resource from among plural host resource candidates, as follows. A plurality of host resource candidates capable of performing execution of the application may be identified by the infrastructure manager based on the context parameters. For example, if a host resource satisfies at least one virtualisation requirement defined by the context parameters, that host resource may be added to a list of host resource candidates. The plurality of host resource candidates may be processed to determine a satisfaction rate for each host resource candidate (i.e. each host resource candidate is checked to determine whether it satisfied each virtualisation requirement).

The satisfaction rate may indicate the proportion of virtualisation requirements that are satisfied by respective host resource candidates. For example, a host resource candidate which satisfied half of the virtualisation requirements may be assigned a satisfaction rate of 50%. In certain embodiments, the satisfaction rate is determined using only virtualisation requirements defined by the context parameters.

Upon determining the satisfaction rates, the plurality of host resource candidates may be ranked based on the determined satisfaction rate. For example, the host resource candidates may be ranked in descending order from highest to lowest satisfaction rate. The host resource candidate with the highest satisfaction rate may be selected as the host resource candidate to perform execution of the application.

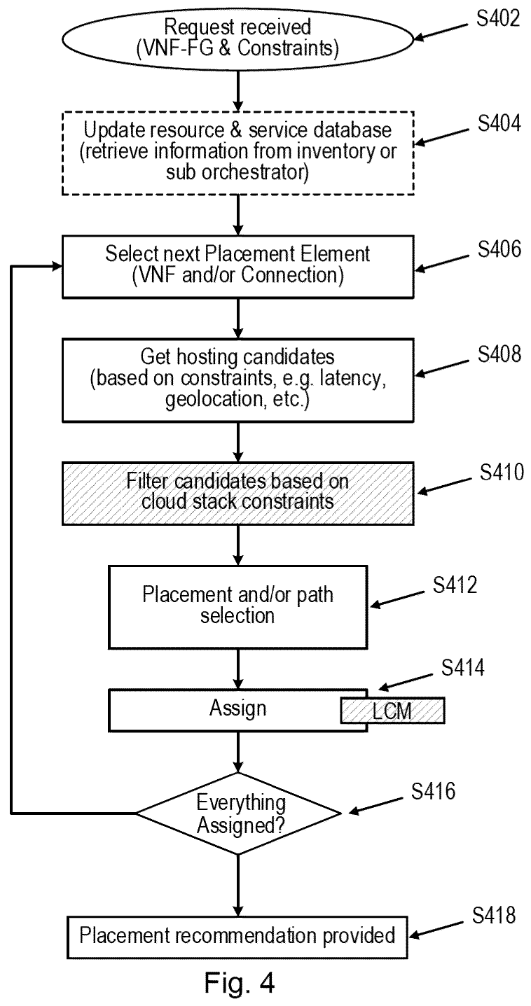

Embodiments of the method of managing plural cloud virtualisation layers by a network node will now be discussed with reference to FIG. 4.

FIG. 4 is a flowchart illustrating an embodiment of the method of managing plural cloud virtualisation layers, in which plural LCMs intersects with a workload placement algorithm (i.e. workflow algorithm).

In step S402, VNFs (i.e. an application) and a VNF-Forwarding Graph (VNF-FG) are received by a workload placement module as part of a service request (also referred to as a request). In step S404, resources information is collected from an inventory and/or from a sub-orchestrator in order that a resource and service update can be executed. The workload placement algorithm selects the next placement element (VNF and/or edge) to be considered in step S406. In step S408, host resource candidates are selected based on constraints such as: latency, geolocation, affinity/anti-affinity rules, etc. (i.e. virtualisation requirements defined by the input parameters).

In step S410, a filtering step is introduced, in which the host resource candidates generated by the workload placement algorithm are filtered according to their capacity to satisfy cloud stack constraints (i.e. virtualisation requirements defined by the input parameters and/or the context parameters). For example, host resource candidates may be filtered based on the ability to support a required decomposition type. In step S412, a placement and/or path selection algorithm is executed, in which feasible placements and/or paths are selected for each host resource candidate and these placements and/or paths are ranked according to their reward/penalty (i.e. satisfaction rate).

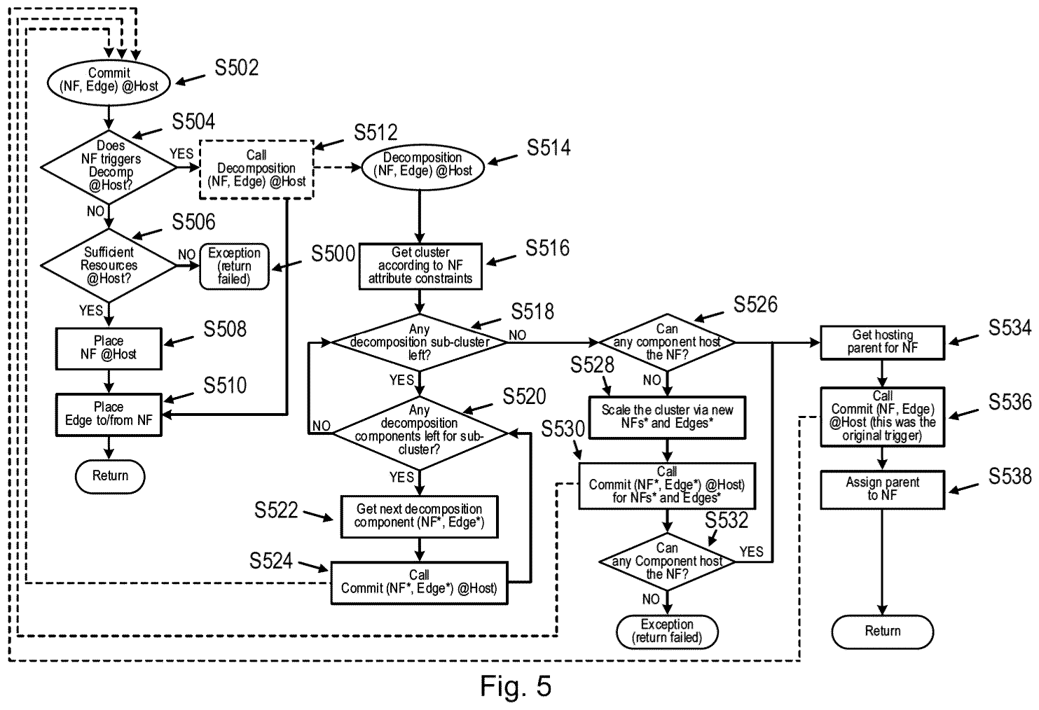

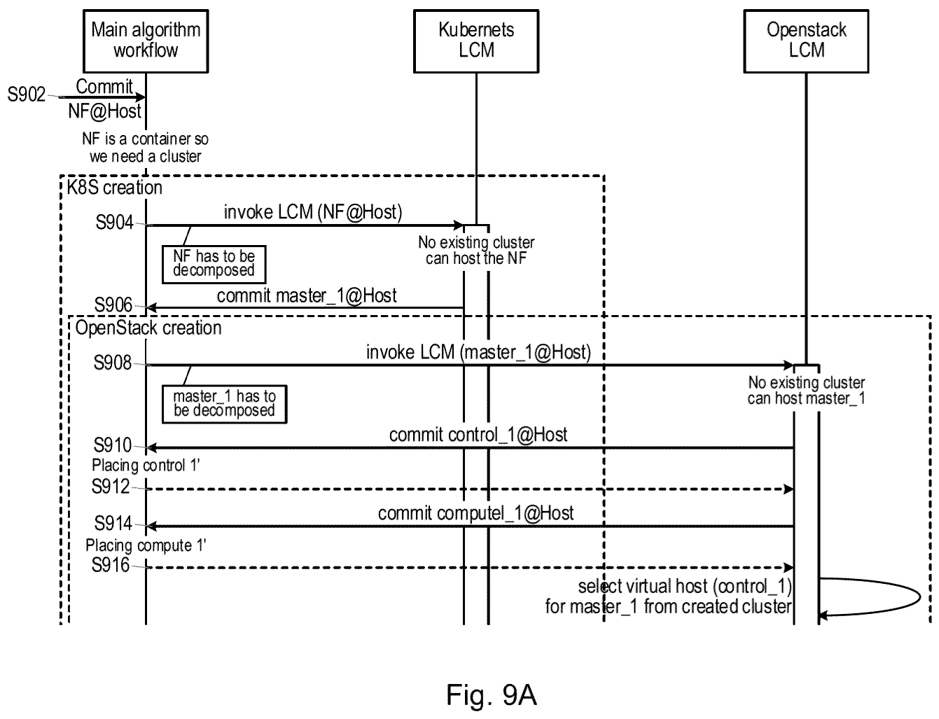

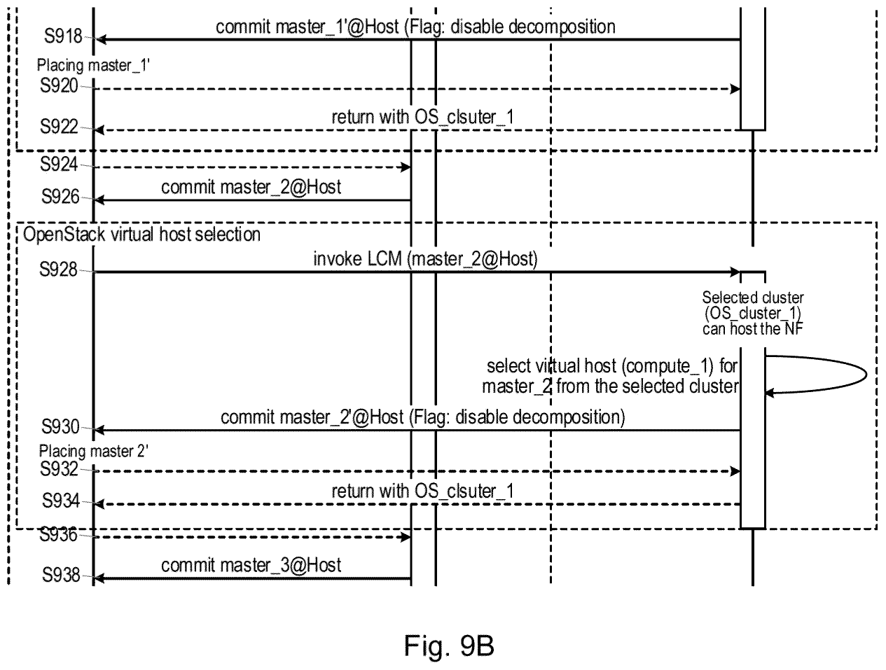

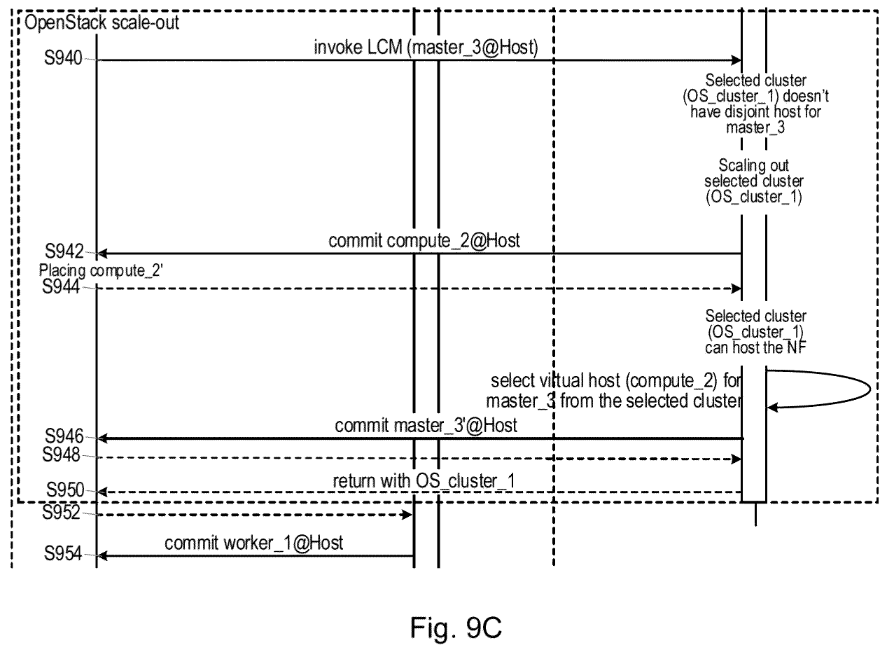

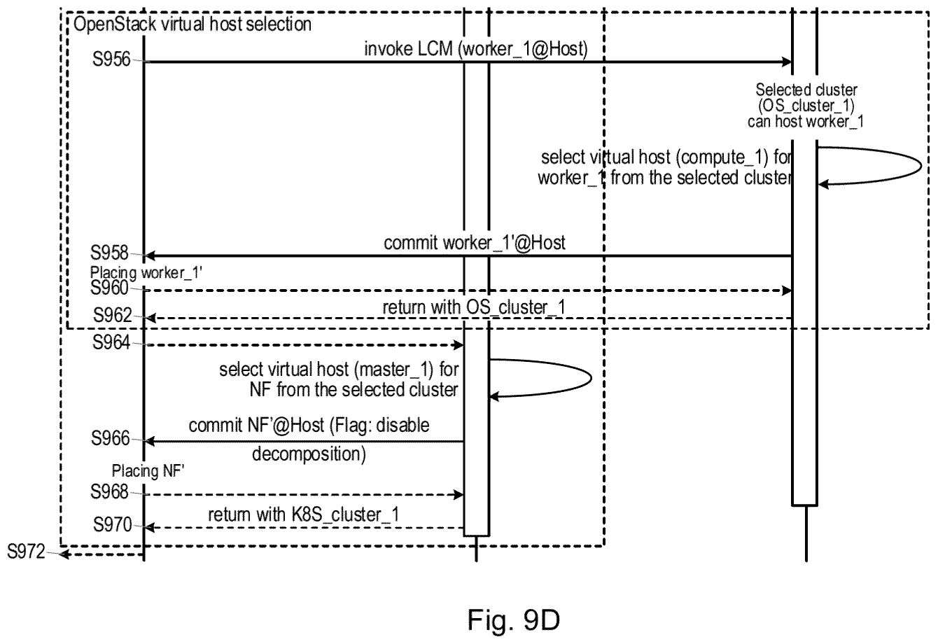

The workload placement algorithm executes an assign request in step S414 which assigns VNFs received with the service request to the highest ranking host resource candidate from step S412. This assign request invokes the relevant LCM (e.g. Kubernetes or OpenStack according to the requested decomposition type or the configuration policy of the selected host resource candidate) which thereby triggers relevant LCM processing. The LCM can select the decomposition options, the isolation level, the software versions, and the deployment flavours (e.g. a VNF manager of a VNF at the time of instantiation). Selection of decomposition options is done based on an input received from the service request (i.e. input parameters) and/or the workload placement algorithm. Accordingly, the relevant LCMs create the required clusters (i.e. clusters of virtualisation layer components) to which the VNFs are assigned. Processing between the workflow algorithm and the LCM is recursive (explained in more detail below in relation to FIG. 5 and FIG. 9).

In step S416, a check is performed to determine if there are any remaining VNFs which have not been assigned. If further VNFs require assignment, the process is restarted with the next VNF. If no further VNFs require assignment, the workload placement algorithm proceeds to step S418 in which a placement recommendation is provided.

FIG. 5 is another flowchart illustrating a more detailed embodiment of the method of managing plural cloud virtualisation layers, in which plural LCMs intersects with a workload placement algorithm.

In step S502, a commit is executed on the workload placement algorithm to place a network function (NF) received as part of the service request and an edge (i.e. a connection between two NFs, such as a connection to or a connection from the NF that is being placed) on a selected host resource candidate. The workload placement algorithm checks whether the NF placed on the selected host resource candidate triggers decomposition or not. If decomposition is triggered, a relevant LCMs (e.g. a OpenStack LCM and a Kubernetes LCM) are called at step S512. In the following description, reference will be made to the relevant LCM. It will be understood that the relevant LCM may be a certain LCM selected from among plural LCMs.

Steps performed by the relevant LCM will now be described in steps S514 to S538.

At step S514, the decomposition trigger arrives at the relevant LCM and at step S516 the relevant LCM starts creating a corresponding cluster of virtualisation layer components according to input parameters (i.e. NF constraints) and/or context parameters provided by the infrastructure manager. The input parameters may be defined by a tenant and/or the workload placement algorithm. The input parameters may include a required redundancy level (e.g. defined in a service level agreement (SLA)), the selected host resource, and the required decomposition type (e.g., OpenStack, Kubernetes). Context parameters provided by the infrastructure manager may also be used by the relevant LCM to create the corresponding cluster of virtualisation layer components. The context parameters may include details of existing clusters of virtualisation layer components stored on the selected host resource which correspond to a service type identified by the relevant LCM. The LCM may update an existing cluster of virtualisation layer components, as follows: additional cluster creation, scaling in or out of a particular cluster and reconfiguration of a particular cluster. In the embodiment illustrated by FIG. 5, the relevant LCM determines the minimum number of virtualisation layer components (e.g. Master(s) and Slaves(s) for Kubernetes or Controller(s) and Compute(s) for OpenStack) needed for the service request according to the input parameters and/or the context parameters. In the present embodiment, a group of Masters and a group of Slaves define two respective sub-clusters within a cluster. Furthermore, Masters may be interconnected in a full-mesh and each Slave may be connected to all Masters.

As mentioned above, the creating of clusters of virtualisation layer components is a recursive process, and therefore, at step S518, the relevant LCM checks if any further decomposition of sub-clusters is required. If further decomposition of at least one sub-cluster is required, the relevant LCM checks whether additional virtualisation layer components are required in order to perform the decomposition at step S520 (e.g. additional Master(s) and Slave(s) for Kubernetes). The NF associated with the decomposition virtualisation layer component may be referred to as NF*. If additional virtualisation layer components are required, the relevant LCM creates the additional virtualisation layer components at step S522. In step S524, the relevant LCM commits the newly created virtualisation layer component and corresponding edge to the workload placement algorithm on the selected host resource.

If further decomposition of at least one sub-cluster is not required, the relevant LCM checks whether the NF can be assigned to any of the decomposed virtualisation layer components at step S526. At step S528, if there are no suitable decomposed virtualisation layer components available, the relevant LCM scales the clusters of virtualisation layer components by creating additional virtualisation layer components (e.g., Masters and/or Slaves for Kubernetes) and edges between them.

At step S530, each newly created virtualisation layer component and corresponding edge is committed to the workload placement algorithm by the relevant LCM thereby requesting placement on the selected host resource.

At step S532, the relevant LCM checks again whether the NF can be assigned to any of the decomposed virtualisation layer components after scaling has been performed at step S528. If there are no suitable decomposed virtualisation layer components available, an exception is raised and execution of the NF is determined to have failed.

At step S534, if all the required clusters have been created and no further decomposition is required, the relevant LCM steps back one level in the recursion process and selects a virtualisation layer component to which the NF should be assigned. That is, if there is a virtualisation layer component with sufficient resources (e.g., CPU, memory, storage) to execute the NF, it is selected and added as a parent to the NF.

In step S536, the relevant LCM returns to the workload placement algorithm in order to commit the NF on the given host resource candidate that was initially requested by the workload placement algorithm.

At step S538, the relevant LCM assigns the selected virtualisation layer component as a parent to the NF. The process then proceeds to return.

Returning to step S504, if the NF does not trigger decomposition, the workload placement algorithm checks whether a requested host resource candidate has sufficiency resources to host the NF at step S506.

If the requested host resource candidate does not have sufficient resources, an exception is raised and execution of the NF is determined to have failed. If the requested host resource candidate does have sufficient resources to host the NF, the workload placement algorithm assigns the NF to the requested host resource candidate at step S508. The workload placement algorithm also assigns the corresponding edge to the requested host resource candidate at step S510 before the process proceeds to return.

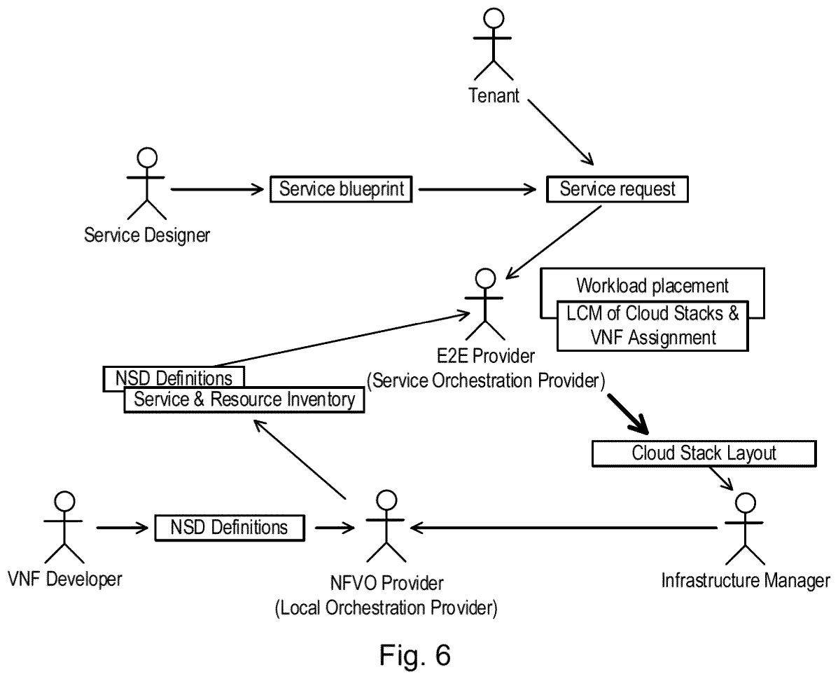

FIG. 6 is a flow diagram illustrating an actor and role model representation of the method of managing plural cloud virtualisation layers. In FIG. 6, the central component of the management method is illustrated as a workload placement and cloud stack LCM automation process (also referred to as workload placement and LCM of cloud stacks & VNF assignment). The workload placement and cloud stack LCM automation engine assigns host resource candidates to service context enriched service blueprints based on the available host resources and network service descriptor (NSD) packages provided by a sub-ordinated orchestration subsystems.

In the actor and mole model of FIG. 6, when a service request arrives at an E2E service orchestration provider from a tenant (a tenant can be any actor, such as: an end user, an enterprise, a third party provider, and a service provider itself). Arrival of the service request triggers the workload placement and cloud stack LCM automation process. The service request may include input parameters provided by the tenant and is complemented with associated policies stored in the E2E service orchestration provider.

A layout of virtualisation layer components for the plural cloud virtualisation layers is generated, for example, by the E2E service orchestration provider. Implementation of the layout of virtualisation layer components may be executed by the infrastructure manager. The actor and mole model includes a cycle between the E2E service orchestration provider, the infrastructure manager, a network functions virtualisation orchestrator (NFVO) (i.e. local orchestration provider), and NSF definitions and service and resource inventory. This cycle embeds the cloud stack LCM automation process in a recursive manner. That is, the cycle may continue recursively (i.e. for more than one cycle) if a cloud virtualisation layer requires different cloud virtualisation layers on a lower level as part of decomposition (e.g. a Kubernetes layer may require an OpenStack layer at a lower level).

Once the layout of virtualisation layer components is complete, the NFVO assigns a VNF included in the service request accordingly.

Embodiments of the present invention therefore provide combined runtime deployment of infrastructure management and VNF orchestration (e.g. the E2E service orchestration provider). This combined runtime deployment may be performed according to at least one of the following steps:
Design and assign virtualisation layer components for applications such as VNFs (i.e. workloads).
Identify the workload's specific decomposition requirements.
Emulate decomposition by: creating new virtualisation layer components, scaling existing clusters of virtualisation layer components, decommissioning a specific cloud virtualisation layer.

The step of emulating decomposition (performed by LCM(s)) may be user programmable via an application programming interface (API). The API may be invoked within the design and assign step. Each step of a decomposition (i.e. a single workload such as a VNF of an application) may trigger a further decomposition with further requirements. Triggering of further decompositions may be a recursive process which is executed until all required virtualisation layer components of each plural cloud virtualisation layer have been created.

The design and assign step may invoke relevant LCMs to generate the layout of virtualisation layer components (including performing decomposition) based on context specific information such as multi-tenancy requirements and isolated deployment requirements (e.g. as part of the context parameters). Each virtualisation layer component may become a resource on which an application may be assigned. All virtualisation layer components may be considered available resources capable of hosting an assigned application. The design and assign step may be executed by connecting the infrastructure manger and the VNF orchestration. The layout of virtualisation layer components is generated in accordance with the necessary dependencies needed to accommodate an application, for example, based on input parameters and/or context parameters.

Programmatical modelling of the behaviour of LCMs for multi-layer cloud stacks may consider a range of different input parameters and context parameters (i.e. virtualisation requirements). Examples of such parameters include:
resiliency, for example, a resilient Kubernetes may require at least three Master component and one Worker component;
multi-tenancy, for example, a Kubernetes layer may be restricted to single tenancy while an OpenStack layer may support multi-tenancy; and
affinity/anti-affinity rules, for example, plural Master components in the same Kubernetes cluster may be required to be allocated to different OpenStack components.

The combined runtime deployment described above may provide the following configuration changes:
Addition, removal and/or modification of the infrastructure management.
Addition, removal and/or modification of VNF orchestrators performing the VNF orchestration.

Advantageously, the method of managing plural cloud virtualisation layers provides a means for LCM automation of plural cloud virtualisation layers (i.e. multi-layer cloud stacks) during service instance design and assign as an extension to a workload placement algorithm. The management method provides LCM automation by handling dependencies between different cloud virtualisation layers (such as OpenStack and Kubernetes) and handling conversion from physical host resources to virtual host resource.

As discussed above, embodiments of the present invention provide combined runtime deployment of infrastructure management and VNF orchestration (e.g. the E2E service orchestration provider). Advantageously, by combining infrastructure management and VNF orchestration into one automation logic, the VNF orchestration environment is lifted to the run-time domain. That is, a new cloud virtualisation layer, together with its VNF orchestration plane, can be on-demand created during run-time. In particular, the management method scales and/or decommissions cloud virtualisation layers together with their VNF orchestration services for immediate service orchestration use. Advantageously, the management method extends elasticity to the cloud virtualisation layers, which provides improved resource utilisation and reduced operating costs.

The method of managing plural cloud virtualisation layers may interface with classical placement workflows (e.g. a workload placement algorithm) to perform the following processes:
collect context information (i.e. context parameters) such as resource constraints and resource topology information;
execute specific LCM for certain cloud virtualisation layers (e.g. OpenStack or Kubernetes). This may be a topology decomposition at a target site/data centre.
interact with subordinate LCMs of different cloud virtualisation layers (e.g. scaling); and
convert physical host resources (e.g. CPUs) to virtual host resources (e.g. vCPUs) while maintaining a connection between the physical and virtual host resources. This conversion is transparent to the workload placement algorithm.

Embodiments of the present invention provide the advantage that operators can jointly manage their services and virtualisation infrastructures by automating mechanisms to instantiate, scale and/or decommission virtualization layers on-demand at the service instance design and assign time. Unlike with traditionally separated virtualisation infrastructure and service lifecycle management, the combined automation according to embodiments of the present invention provides improved composition and usage of physical resources. This is achieved by introducing elasticity into the virtualisation layers as discussed in detail above and below.

In order to aid in the understanding of embodiments of the present invention, a specific embodiment of NF deployment on multi-layer cloud stacks will now be discussed in relation to FIG. 7. In FIG. 7, virtualisation components corresponding to OpenStack and Kubernetes layers are described, but it will be understood that alternative virtualisation layers could be used in addition to or instead of OpenStack and/or Kubernetes.

FIG. 7 illustrates an embodiment of the management method in which an NF belonging to a service request is deployed to a host resource such as a National Data Centre (NDC). In the embodiment illustrated by FIG. 7, a Kubernetes cloud virtualisation layer comprises a first cluster having the following virtualisation layer components: Master_1, Master_2, Master_3, and Worker_1. The OpenStack cloud virtualisation layer comprises a second cluster having the following virtualisation components: Controller_1, Compute_1, and Compute_2. The arrangement of virtualisation layer components in FIG. 7 is an example layout of virtualisation layer components for plural cloud virtualisation layers. The layout also illustrates decomposition of Kubernetes virtualisation layer components onto an OpenStack virtualisation layer. The arrows represent connections between the virtualisation layer components.

In order to assign the NF of the service request, firstly a host resource is selected, e.g. the NDC. Before assignment, hosting candidates are generally empty. If the NF to be assigned is a container, then there is a need for a Kubernetes cluster. According to the embodiment illustrated in FIG. 7, the Kubernetes cluster must be placed inside an OpenStack cluster. If there is an existing OpenStack cluster this may be used, otherwise a new OpenStack cluster is created. The Kubernetes cluster is created inside that OpenStack cluster, and finally the NF is assigned to a component of the Kubernetes cluster (i.e. Master_1).

In the embodiment of FIG. 7, the input parameters define the following multi-tenancy requirements: the Kubernetes cluster is restricted to a single tenant and the OpenStack cluster may be multi-tenant. Therefore, according to these specific input requirements, if a second service request is received from a second tenant, the Kubernetes LCM would recognise that the Kubernetes cluster cannot be shared with the second tenant. In order to avoid a multi-tenancy arrangement of the Kubernetes cluster, the Kubernetes LCM creates a second Kubernetes cluster for a second NF of the second service request. However, the already created OpenStack cluster is shared (if it has sufficient resources) and the new Kubernetes cluster is created inside the shared OpenStack cluster. The second NF is then assigned to the new Kubernetes cluster.

The multi-tenancy requirements of cloud virtualisation layers may differ according to their specific input parameters.

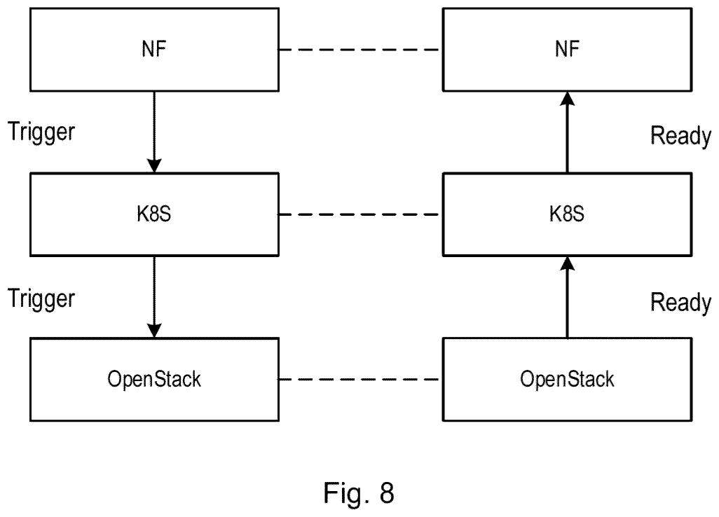

The manner in which multi-layer cloud stacks (i.e. plural cloud virtualisation layers) are triggered and created will now be discussed in relation to FIG. 8.

FIG. 8 illustrates a top-down approach for triggering the creation of multi-layer cloud stacks (i.e. OpenStack and Kubernetes), in which an initial trigger comes from the event of assigning an NF to a requested host resource candidate (e.g. step S502 in FIG. 5). Lower level cloud virtualisation layers receive a trigger from the layer directly above them.

As illustrated in FIG. 8, creation of multi-layer cloud stacks follows a bottom-up approach, in which creation of lower level cloud virtualisation layers is completed before creation of higher level cloud virtualisation layers is completed.

A more detailed explanation of the embodiment illustrated in FIG. 7 will now be discussed in relation to the flowchart of FIG. 9. The following description of FIG. 9 is a detailed explanation of how NF deployment on multi-layer cloud stacks is executed, how the relevant LCMs corresponding to different cloud stack layers are automated, and how cloud stack layers are created, scaled, or decommissioned. The resiliency policy configured for Kubernetes clusters (e.g. as defined by the input parameters) in this embodiment is three Masters and one Worker.

FIG. 9 illustrates a sequence of step which involve the following three actors: the workload placement algorithm (i.e. a main algorithm workflow), a Kubernetes LCM, and an OpenStack LCM. The sequence starts at step S902 when the Kubernetes LCM receives a commit request from the workload placement algorithm to assign an NF to a selected host resource candidate. The workload placement algorithm invokes the Kubernetes LCM after finding that the NF is a container and it needs to be decomposed.

The Kubernetes creation process starts at step S904 when the Kubernetes LCM is invoked by the workload placement algorithm. The Kubernetes LCM finds that there is no existing Kubernetes cluster that can be used, and therefore it starts creating the virtualisation layer components of a new Kubernetes cluster. The Kubernetes LCM creates the first virtualisation layer component (i.e. master_1, in FIG. 7), and in step S906 commits master_1 to the workload placement algorithm thereby requesting its placement on the selected host resource candidate (as specified in the initial commit request).

The OpenStack creation process starts at step S908 when the workload placement algorithm identifies that the virtualisation layer component master_1 is a Kubernetes component. Based on the configuration of the hosting node (i.e. as defined by the context parameters) and/or the input parameters, the creation process determines that this Kubernetes component must be placed inside an OpenStack cluster. Accordingly, the workload placement algorithm invokes the OpenStack LCM at step S908. The OpenStack LCM determines that there is no existing OpenStack cluster on which the master_1 component can be placed, and therefore the OpenStack LCM starts creating a new OpenStack cluster by creating a first OpenStack virtualisation layer component (i.e. controller_1). At step S910, the OpenStack LCM invokes the workload placement algorithm to request placement of controller_1 on the selected host resource candidate. At step S12, the workload placement algorithm determines that no further decomposition is needed, commits the controller_1 on the selected host resource candidate. The workload placement algorithm returns back to the OpenStack LCM at step S912.

The OpenStack LCM determines that a further OpenStack component is required and creates the second OpenStack component (i.e. compute_1). At step S914, the OpenStack LCM commits compute_1 to the workload placement algorithm thereby requesting its placement on the selected host resource candidate. When it is determined that OpenStack cluster creation is finished, the OpenStack LCM selects a virtualisation layer component (i.e. a virtual host) from the OpenStack cluster (e.g. controller_1) to host master_1 at step S916. The OpenStack LCM then commits master_1 by calling back the workload placement algorithm at step S918. This commit is sent with the flag “disable decomposition” indicating to the workload placement algorithm that OpenStack cluster creation has finished. Hence, at step S920 the workload placement algorithm assigns the master_1 component to the selected host resource candidate and notifies the OpenStack LCM accordingly. The OpenStack LCM returns the created OpenStack cluster with the ID “OS_cluster_1” to the workload placement algorithm at step S922.

The Kubernetes creation process continues at step S924, where the Kubernetes LCM creates a master_2 component and commits master_2 to the workload placement algorithm for assignment at step S926.

An OpenStack virtual host selection process begins at step S928 by invoking the OpenStack LCM again. At this stage, the OpenStack LCM directly selects a virtual host for master_2 from the OpenStack cluster (e.g. compute_1). At step S930, the OpenStack LCM then commits master_2 to the workload placement algorithm with the flag “disable decomposition” to avoid further decomposition requests by the workload placement algorithm. The workload placement algorithm assigns master_2 to the virtual host compute_1 at step S932. The OpenStack LCM again returns the created OpenStack cluster with the ID “OS_cluster_1” to the workload placement algorithm at step S934.

The Kubernetes creation process continues at step S936 as the workload placement algorithm calls the Kubernetes LCM to continue Kubernetes cluster creation. Accordingly, the Kubernetes LCM creates master_3 and commits master_3 to the workload placement algorithm at step S938.

An OpenStack scale-out process begins at step S940 when the workload placement algorithm invokes the OpenStack LCM to identify a virtual host for master_3. The OpenStack LCM notices that OpenStack cluster OS_cluster_1 has already been created and is capable of virtually hosting master_3. Hence, the OpenStack LCM selects a virtual host from OS_cluster_1 to host master_3. However, the OS_cluster_1 is configured with affinity/anti-affinity rules (i.e. according to the input parameters) which indicate that Master components in the Kubernetes cluster should be allocated to different OpenStack components. The OpenStack LCM identifies that it does not have a disjoint virtual host for master_3. Hence, the OpenStack LCM starts scaling out OS_cluster_1 by creating a new OpenStack component (i.e. compute_2). Compute_2 is committed to the workload placement algorithm at step S942 for placement to the selected host resource candidate. Once compute_2 is placed, the OpenStack LCM selects compute_2 to virtually host master_3 at step S944. At step S946, master_3 is again committed to the workload placement algorithm for placement at step S948. At step S950, the OpenStack LCM returns to the workload placement algorithm with OS_cluster_1. It will be understood that OS_cluster_1 can be scaled to include further Controller components and/or Compute components as necessary.

The Kubernetes creation process continues at step S952 as the workload placement algorithm calls the Kubernetes LCM to continue Kubernetes cluster creation. The Kubernetes LCM creates worker_1 and commits worker_1 to the workload placement algorithm for placement at step S954.

The OpenStack virtual host selection process starts for worker_1 at step S956 by invoking the OpenStack LCM again. At this stage, the OpenStack LCM directly selects a virtual host for worker_1 from the OpenStack cluster (e.g. compute_1). At step S958, the OpenStack LCM then commits worker_1 to the workload placement algorithm for placement. The workload placement algorithm assigns worker_1 to the virtual host compute_1 at step S960. The OpenStack LCM again returns the created OpenStack cluster with the ID “OS_cluster_1” to the workload placement algorithm at step S962.

In step S964, the Kubernetes creation process continues, where in the Kubernetes LCM selects a virtualisation layer component to which the NF should be assigned (i.e. master_1). The NF is committed to the workload placement algorithm at step S966 with the flag “disable decomposition” to indicate the end of the Kubernetes cluster creation. Accordingly, the workload placement algorithm assigns the NF to master_1 at step S968. The Kubernetes LCM returns the created Kubernetes cluster with the ID (k8s_cluster_1) to the workload placement algorithm at step S970. The sequence finished at step S972. It will be understood that k8s_cluster_1 can be scaled to include further Master components and/or Worker components as necessary.

It will be understood that the detailed examples outlined above are merely examples. According to embodiments herein, the steps may be presented in a different order to that described herein. Furthermore, additional steps may be incorporated in the method that are not explicitly recited above. For the avoidance of doubt, the scope of protection is defined by the claims.

1. A method of managing plural cloud virtualisation layers in a communication network, the method comprising:
receiving, from a tenant, a service request to execute an application on a host resource, wherein the service request comprises input parameters;
determining, based on the input parameters, that execution of the application on the host resource requires plural cloud virtualisation layers;
responsive to determining that execution requires plural cloud virtualisation layers, generating a layout of virtualisation layer components for the plural cloud virtualisation layers; and
assigning the application to a virtualisation layer component based on the input parameters.

2. The method according to claim 1, wherein:
the input parameters define virtualisation requirements comprising at least one of:
required resource constraints, required redundancy level, and required decomposition type, and the layout of virtualisation layer components is generated by creating clusters of virtualisation layer components for respective cloud virtualisation layers according to at least one of: the required resource constraints, the required redundancy level, and the required decomposition type.

3. The method according to claim 2, wherein the method further comprises:
receiving, from an infrastructure manager, context parameters, wherein the context parameters define virtualisation requirements comprising at least one of: host resource constraints, dependencies between cloud virtualisation layers, and host resource topology, and wherein:
determining that assignment of the application to the host resource requires plural cloud virtualisation layers is determined based on the input parameters and the context parameters,
the layout of virtualisation layer components is generated by creating clusters of virtualisation layer components for respective cloud virtualisation layers according to at least one of: the required resource constraints, the required redundancy level, the required decomposition type, the host resource constraints, the dependencies between cloud virtualisation layers, and the host resource topology, and
the application is assigned to a virtualisation layer component based on the input parameters and the context parameters.

4. The method according to claim 2, wherein the required resource constraints comprise: latency rules, geolocation rules, affinity rules, anti-affinity rules, multi-tenant rules, capacity rules, and link bandwidth utilisation rules.

5. The method according to claim 2, wherein virtualisation layer components are recursively generated for respective clusters of virtualisation layer components until the maximum number of virtualisation requirements is satisfied.

6. The method according to claim 2, wherein the application is assigned to one or more virtualisation layer components based on the virtualisation requirements.

7. The method according to claim 3, wherein:
the context parameters further define the virtualisation requirement of existing host resource topology, the existing host resource topology indicating an existing cluster of virtualisation layer components on the host resource.

8. The method according to claim 7, wherein the method further comprises:
selecting the existing cluster of virtualisation components to be used in generating the layout of virtualisation layer components.

9. The method according to claim 7, wherein the method further comprises:
updating the existing cluster of virtualisation components and selecting the updated cluster of virtualisation components to be used in generating the layout of virtualisation layer components.

10. The method according to claim 7, wherein the method further comprises:
creating new virtualisation components to be used in addition to the existing cluster of virtualisation layer components in generating the layout of virtualisation layer component.

11. The method according to claim 1, wherein generating the layout of virtualisation layer components for the plural cloud virtualisation layers further comprises:
decommissioning one of the plural cloud virtualisation layers.

12. The method according to claim 2, wherein the method further comprises:
identifying a plurality of host resource candidates to perform execution of the application,
processing the plurality of host resource candidates to determine a satisfaction rate for each host resource candidate, the satisfaction rate indicating the proportion of virtualisation requirements satisfied by respective host resource candidates,
ranking the plurality of host resource candidates based on the determined satisfaction rates, and
selecting the host resource candidate with the highest satisfaction rate as the host resource candidate to perform execution of the application.

13. The method according to claim 1, wherein the method further comprises:
executing the application on the host resource in the assigned virtualisation layer component.

14. The method according to claim 1, wherein the host resource is a virtual host resource, and the method further comprises:
converting a physical host resource to the virtual host resource.

15. The method according to claim 1, wherein the plural cloud virtualisation layers comprise at least one of an OpenStack virtualisation layer and a Kubernetes virtualisation layer.

16. A network node configured to manage plural cloud virtualisation layers in a communication network, the network node comprising processing circuitry and a memory containing instructions executable by the processing circuitry, whereby the network node is operable to:
receive, from a tenant, a service request to execute a application on a host resource, wherein the service request comprises input parameters;
determine, based on the input parameters, that execution of the application on the host resource requires plural cloud virtualisation layers;
responsive to determining that execution requires plural cloud virtualisation layers, generate a layout of virtualisation layer components for the plural cloud virtualisation layers; and
assign the application to a virtualisation layer component based on the input parameters.

17. The network node according to claim 16, wherein:
the input parameters define virtualisation requirements comprising at least one of: required resource constraints, required redundancy level, and required decomposition type, and
the layout of virtualisation layer components is generated by creating clusters of virtualisation layer components for respective cloud virtualisation layers according to at least one of: the required resource constraints, the required redundancy level, and the required decomposition type.

18. The network node according to claim 17, wherein the network node is further operable to:
receive, from an infrastructure manager, context parameters, wherein the context parameters define virtualisation requirements comprising at least one of: host resource constraints, dependencies between cloud virtualisation layers, and host resource topology, and wherein:
determine that assignment of the application to the host resource requires plural cloud virtualisation layers is determined based on the input parameters and the context parameters,
the layout of virtualisation layer components is generated by creating clusters of virtualisation layer components for respective cloud virtualisation layers according to at least one of: the required resource constraints, the required redundancy level, the required decomposition type, the host resource constraints, the dependencies between cloud virtualisation layers, and the host resource topology, and
the application is assigned to a virtualisation layer component based on the input parameters and the context parameters.

19-25. (canceled)

26. The network node according to claim 16, wherein the network node is further operable to generate the layout of virtualisation layer components for the plural cloud virtualisation layers by decommissioning one of the plural cloud virtualisation layers.

27-30. (canceled)

31. A computer-readable medium comprising instructions which, when executed on a computer, cause the computer to perform a method in accordance with claim 1.
